(19) United States
(12) Patent Application Publication
(10) Pub. No.: US 2025/0199555 A1
(43) Pub. Date: Jun. 19, 2025

(54) VOLTAGE REGULATOR WITH SWITCHING CIRCUITRY

(71) Applicant: NXP USA, Inc., AUSTIN, TX (US)

(72) Inventor: Paolo Migliavacca, Mauzac (FR)

(21) Appl. No.: 18/964,999

(22) Filed: Dec. 2, 2024

(30) Foreign Application Priority Data
Dec. 19, 2023 (EP) 23307253.7

(51) Int. Cl. G05F 1/575; G05F 1/569

(52) U.S. Cl. CPC G05F 1/575; G05F 1/569

(57) ABSTRACT

A voltage regulator is described that includes an error amplifier configured to provide an error signal based on a comparison of a reference voltage and a voltage at a voltage divider coupled to an output node of the voltage regulation circuit, a pass transistor configured to selectively pass current from an input node to the output node based on the error signal, and switching circuitry configured to selectively couple one of a first voltage supply input and a second voltage supply input to the input node. The switching circuitry includes a first leg that includes a first switch and a transistor that is coupled in a cascode arrangement with the pass transistor and a second leg that includes a second switch.

### TECHNICAL FIELD

Embodiments of the subject matter described herein relate generally to regulators, including low-dropout regulators with switching circuitry for voltage supply input selection.

### BACKGROUND

Linear voltage regulators, such as low-dropout (LDO) regulators, generate a regulated direct current (DC) output voltage from a received supply voltage. LDO regulators, in particular, are used in many applications because of its ability to linearly regulate output voltage, even when the supply voltage is very close to the output voltage. LDOs tend to generate less noise and may be smaller than other types of regulators.

### SUMMARY

A brief summary of various exemplary embodiments is presented below. Some simplifications and omissions may be made in the following summary, which is intended to highlight and introduce some aspects of the various exemplary embodiments, without limiting the scope. Detailed descriptions of an exemplary embodiment adequate to allow those of ordinary skill in the art to make and use these concepts will follow in later sections.

In an example embodiment, a voltage regulation circuit includes an error amplifier configured to provide an error signal based on a comparison of a reference voltage and a voltage at a voltage divider coupled to an output node of the voltage regulation circuit, a pass transistor configured to selectively pass current from an input node to the output node based on the error signal, and switching circuitry configured to selectively couple one of a first voltage supply input and a second voltage supply input to the input node. The switching circuitry includes a first leg that coupled between the first voltage supply input and the input node, the first leg including a transistor that is coupled in a cascode arrangement with the pass transistor, and a second leg coupled between the second voltage supply input and the input node.

In one or more embodiments, the voltage regulation circuit further includes a charge pump having an input coupled to the output node, the charge pump being configured to generate a charge pump voltage, and a cascode driver configured to receive the charge pump voltage and to control an amount of current passing through the transistor of the first leg.

In one or more embodiments, the voltage regulation circuit further includes a first switch included in the first leg, a second switch included in the second leg, and one or more switch drivers coupled to the first switch and the second switch and configured to control the first switch and the second switch.

In one or more embodiments, the transistor of the first leg is a first nMOS power transistor having a first voltage rating and the pass transistor is a second nMOS power transistor having a second voltage rating that is less than the first voltage rating.

In one or more embodiments, when the output node is at zero volts and the first voltage supply input is selected, the transistor of the first leg is configured to dissipate a majority of power in the voltage regulation circuit.

In one or more embodiments, when the output node is at zero volts and the second voltage supply input is selected, the pass transistor is configured to dissipate a majority of power in the voltage regulation circuit.

In one or more embodiments, the first voltage supply input is configured to receive a first voltage, the second voltage supply input is configured to receive a second voltage, and the first voltage is greater than the second voltage.

In one or more embodiments, the voltage regulation circuit further includes current limiter circuitry coupled to a gate of the pass transistor and configured to limit current through the pass transistor.

In an example embodiment, a low-dropout regulator includes an output node, a voltage divider coupled to the output node, an error amplifier configured to generate an error signal based on a comparison of a reference voltage and a voltage at the voltage divider, a pass transistor configured to receive the error signal from the error amplifier and to selectively pass current from an input node to the output node based on the error signal, and switching circuitry including a first leg coupled between a first voltage supply input and the input node, the first leg including a cascode transistor that is coupled in a cascode arrangement with the pass transistor, and a second leg coupled between a second voltage supply input and the input node, the second leg being coupled in parallel with the first leg.

In one or more embodiments, the low-dropout regulator further includes a charge pump having an input coupled to the output node, the charge pump being configured to generate a charge pump voltage, and a cascode driver configured to receive the charge pump voltage and to control an amount of current passing through the cascode transistor.

In one or more embodiments, the cascode transistor is a first nMOS power transistor having a first voltage rating and the pass transistor is a second nMOS power transistor having a second voltage rating that is less than the first voltage rating.

In one or more embodiments, when the output node is shorted to ground and the first leg is active, the cascode transistor is configured to dissipate a first amount of power and the pass transistor is configured to dissipate a second amount of power that is less than the first amount of power.

In one or more embodiments, when the output node is shorted to zero volts and the second leg is active, the pass transistor is configured to dissipate a majority of power in the low-dropout regulator.

In one or more embodiments, the first voltage supply input is configured to receive a first voltage, the second voltage supply input is configured to receive a second voltage, and the first voltage is greater than the second voltage.

In one or more embodiments, the low dropout regulator further includes current limiter circuitry coupled a gate of the pass transistor and configured to limit current through the pass transistor.

In an example embodiment, a power management integrated circuit includes a battery, a direct-current (DC)-DC converter coupled to the battery, and a voltage regulation circuit configured to generate a regulated output voltage at an output node. The voltage regulation circuit includes a voltage divider coupled to the output node, an error amplifier configured to generate an error signal based on a comparison of a reference voltage and a voltage at the voltage divider, a pass transistor configured to receive the error signal from the error amplifier and to selectively pass current from an input node to the output node based on the error signal, and switching circuitry that includes a first leg coupled between the battery and the input node, the first leg including a cascode transistor that is coupled in a cascode arrangement with the pass transistor, and a second leg coupled between the DC-DC converter and the input node, the second leg being coupled in parallel with the first leg.

In one or more embodiments, the power management integrated circuit further includes a charge pump having an input coupled to the output node, the charge pump being configured to generate a charge pump voltage, and a cascode driver configured to receive the charge pump voltage and to control an amount of current passing through the cascode transistor.

In one or more embodiments, the cascode transistor is a first nMOS power transistor having a first voltage rating and the pass transistor is a second nMOS power transistor having a second voltage rating that is less than the first voltage rating.

In one or more embodiments, when the output node is shorted to ground and the first leg is active, the cascode transistor is configured to dissipate a first amount of power and the pass transistor is configured to dissipate a second amount of power that is less than the first amount of power.

In one or more embodiments, when the output node is shorted to zero volts and the second leg is active, the pass transistor is configured to dissipate a majority of power in the low-dropout regulator.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures. Elements in the figures are illustrated for simplicity and clarity and have not necessarily been drawn to scale. The figures along with the detailed description are incorporated and form part of the specification and serve to further illustrate examples, embodiments and the like, and explain various principles and advantages, in accordance with the present disclosure, wherein:

FIG. 1 is a block diagram of an illustrative low-dropout (LDO) regulator coupled to multiple selectable voltage supply inputs, where switching circuitry coupled to the voltage supply inputs includes a cascoded high voltage input leg, in accordance with various embodiments; and

FIG. 2 is a block diagram of an illustrative system having a power management integrated circuit (PMIC) that includes the LDO regulator of FIG. 1, in accordance with various embodiments.

### DETAILED DESCRIPTION

The following detailed description is merely illustrative in nature and is not intended to limit the embodiments of the subject matter or the application and uses of such embodiments. Furthermore, there is no intention to be bound by any expressed or implied theory presented in the preceding technical field, background, or the following detailed description.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements or regions in the figures may be exaggerated relative to other elements or regions to help improve understanding of embodiments described herein.

The terms “first,” “second,” “third,” “fourth” and the like in the description and the claims, if any, may be used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “comprise,” “include,” “have” and any variations thereof, are intended to cover non-exclusive inclusions, such that a process, method, article, or apparatus that comprises a list of elements is not necessarily limited to those elements but may include other elements not expressly listed or inherent to such process, method, article, or apparatus. The term “coupled,” as used herein, is defined as directly or indirectly connected in an electrical or non-electrical manner. As used herein the terms “substantial” and “substantially” mean sufficient to accomplish the stated purpose in a practical manner and that minor imperfections, if any, are not significant for the stated purpose. As used herein, the words “exemplary” and “example” mean “serving as an example, instance, or illustration.” Any implementation described herein as exemplary or an example is not necessarily to be construed as preferred or advantageous over other implementations. In addition, certain terms may also be used herein for reference only, and thus are not intended to be limiting.

Directional references such as “top,” “bottom,” “left,” “right,” “above,” “below,” and so forth, unless otherwise stated, are not intended to require any preferred orientation and are made with reference to the orientation of the corresponding figure or figures for purposes of illustration.

Various embodiments described herein relate to voltage regulators, such as low-dropout (LDO) regulators with multiple selectable voltage supply inputs, where a high voltage leg of switching circuitry that is used to select between the voltage supply inputs includes a first power transistor (sometimes referred to herein as a “cascode transistor”) that is in a cascode arrangement with a second power transistor (sometimes referred to herein as a “pass transistor”) of the voltage regulator. For example, the cascode transistor of an illustrative voltage regulator may have a higher voltage rating, relative to the voltage rating of the pass transistor, and power dissipation through the cascode transistor may be greater than the power dissipation through the pass transistor during scenarios in which the output of the regulator is shorted (e.g., shorted to 0 V). In contrast, conventional voltage regulator approaches may be arranged such that a majority of power dissipation is concentrated in a single pass transistor in the event of a short, resulting in undesirably higher temperature at the pass transistor than if the power dissipation were distributed between two or more devices.

In one or more embodiments, an illustrative voltage regulator may include an error amplifier, current limiter circuitry, and a pass transistor. The voltage regulator may be coupled to two or more selectable voltage supply inputs via the switching circuitry, such that the error amplifier, current limiter circuitry, and pass transistor may be used with multiple voltage supply inputs. In contrast, conventional voltage regulator approaches may require respective error amplifiers, current limiters, and pass transistors for each voltage supply input, which requires undesirably higher cost, larger footprint, and greater design complexity.

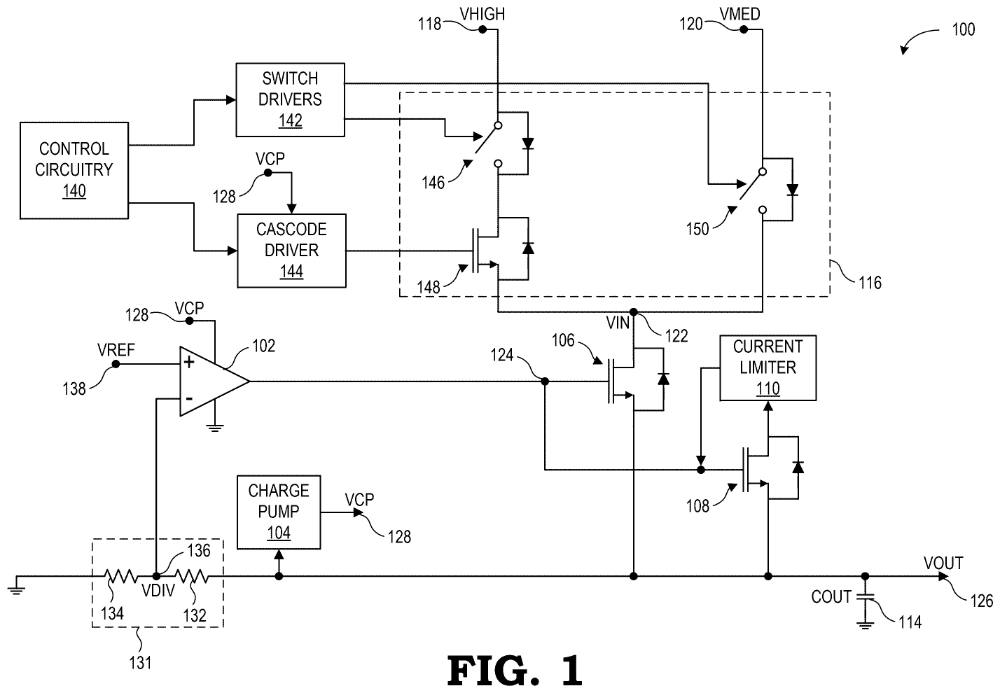

FIG. 1 is a block diagram of a low-dropout (LDO) regulator 100 (sometimes referred to as a “linear regulator 100” or a “voltage regulation circuit 100”) having an input node 122 that is selectively coupled to multiple voltage supply inputs via switching circuitry 116. A high voltage path (sometimes referred to as a “high voltage leg”) of the switching circuitry 116 may include a transistor 148 (sometimes referred to herein as a “cascode transistor 148”) that is coupled in a cascode arrangement with a transistor 106 (sometimes referred herein to as a “pass transistor 106”) of the LDO regulator 100. The cascode arrangement of the transistor 148 and the pass transistor 106 may provide suitable power dissipation in the LDO regulator 100 during, for example, a short circuit condition (i.e., shorted to ground, 0 V, or another applicable reference potential) at an output node 126 of the LDO regulator 100, as described further below.

While the switching circuitry 116 of the present example is described with reference to an LDO regulator, it should be understood that this is intended to be illustrative and non-limiting. For example, the switching circuitry 116, and particularly the cascode arrangement of the high voltage leg thereof, may be used with other suitable voltage regulator arrangements, in accordance with one or more other embodiments.

As shown, the LDO regulator 100 may include an error amplifier 102, a charge pump 104, the pass transistor 106, a transistor 108 (sometimes referred to herein as a “sense transistor 108”), a current limiter circuitry 110, an output capacitor 114, the switching circuitry 116, control circuitry 140, switch drivers 142, and a cascode driver 144. The error amplifier 102 may be a differential amplifier having a non-inverting input, and inverting input, and an output, in accordance with one or more embodiments. The non-inverting input of the error amplifier 102 may be coupled to a reference node 138 at which a reference voltage VREF is provided (e.g., by a reference voltage supply; not shown). In one or more embodiments, the reference voltage VREF may be between around 1 V to around 1.2 V, as a non-limiting example. The inverting input of the error amplifier 102 may be coupled to a node 136 of a voltage divider 131 that includes a resistor 132 having a resistance R1 and a resistor 134 having a resistance R2, where the resistors 132 and 134 are coupled in series between an output node 126 of the LDO regulator 100 and a ground or reference node, and the node 136 is coupled between the resistors 132 and 134. The output of the error amplifier 102 may be coupled to the gate of the pass transistor 106 and the gate of the sense transistor 108 via the node 124. The voltage signal output by the error amplifier 102 is sometimes referred to herein as an “error signal” and may control the amount of current allowed to pass through the pass transistor 106 (i.e., from a drain terminal of the pass transistor 106 to a source terminal of the pass transistor 106; between current-carrying terminals of the pass transistor 106), thereby adjusting the voltage VOUT at the output node 126. That is, the pass transistor 106 may selectively pass current from the input node 122 to the output node 126 based on the error signal output by the error amplifier 102. The voltage VDIV at the node 136 of the voltage divider 131 may be a fraction of the voltage VOUT that is compared to the reference voltage VREF by the error amplifier 102 to determine the output voltage of the error amplifier 102. For example, VDIV may be equal to VOUT*(R2/(R1+R2)). In this way, the error amplifier 102 may regulate the voltage VOUT at the output node 126. It should be understood that, herein, a “ground node” may refer to a node that receives or is connected to a ground voltage, common voltage, or another suitable reference potential (e.g., 0 V), in accordance with various embodiments. Herein, the “gate terminal” or “base terminal” of a transistor may sometimes be referred to as a “control terminal”, and the “drain terminal” and “source terminal” of a transistor may sometimes be referred to as “current-carrying terminals.”

The sense transistor 108 may provide current sensing for the current limiter circuitry 110, with the current level through the sense transistor 108 corresponding to the current level through the pass transistor 106. The current limiter circuitry 110 may limit the current through the pass transistor 106 to a predefined current level (e.g., 100 mA as a non-limiting example) based on the current through the sense transistor 108 by providing a feedback signal to the node 124, which adjusts the voltage at the node 124 to limit the current allowed to pass through the pass transistor 106 and the sense transistor 108. The area ratio between the pass transistor 106 and the sense transistor 108 may define the ratio of current through the pass transistor 106 to current through the sense transistor 108.

The charge pump 104 may include an input coupled to the output node 126 and may be configured to generate and provide, at an output node 128, a voltage VCP (sometimes referred to herein as a “charge pump voltage”) based on the output voltage VOUT. For example, the charge pump 104 may provide the voltage VCP to various elements of the LDO regulator 100, such as the error amplifier 102 and the cascode driver 144 as non-limiting examples. In one or more embodiments, the charge pump 104 is configured to generate the voltage VCP at a voltage level equal to or approximately equal to 10 V, as a non-limiting example. Herein, an example amount that is said to be “around” or “approximately” a given value is considered to be within+/−10% of the given value unless otherwise indicated.

The switching circuitry 116 may be controlled by the control circuitry 140 in conjunction with the switch drivers 142 and the cascode driver 144 to selectively connect one of a high voltage supply input 118, at which a high supply voltage VHIGH is provided (e.g., by a battery of a system that includes the LDO regulator 100), and a medium voltage supply input 120, at which a medium supply voltage VMED is provided (e.g., by a direct current (DC)-DC converter of the system that includes the LDO regulator 100) to the input node 122. The input node 122 may be coupled to a drain terminal of the pass transistor 106. The switching circuitry 116 may include a high voltage leg coupled between the high voltage supply input 118 and the input node 122, where the high voltage leg includes a switch 146 and the transistor 148, and a medium voltage leg coupled between the medium voltage supply input 120 and the input node 122, where the medium voltage leg includes a switch 150. The medium voltage leg may be coupled in parallel with the high voltage leg.

The cascode driver 144 may receive control signals from the control circuitry 140. The output node 128 of the charge pump 104 may be coupled to a supply input of the cascode driver 144, and the voltage VCP may act as a positive supply voltage for the cascode driver 144. The output of the cascode driver 144 may be coupled to the gate of the transistor 148, such that the cascode driver 144 controls the current through the transistor 148. For example, the cascode driver 144 may be selectively configured, by the control circuitry 140, to either place the transistor 148 in a “conducting” or “low impedance” state or place the transistor 148 in a “non-conducting” or “high impedance” state by adjusting a gate voltage that the cascode driver 144 provides to a gate terminal of the transistor 148.

The switch 146 in the high voltage leg of the switching circuitry 116 and the switch 150 in the medium voltage leg of the switching circuitry 116 may each be controlled by the switch drivers 142. For example, the switch 146 may be controlled by a different switch driver than that used to control the switch 150, at least because the switch 146 must be capable of handling higher voltages than the switch 150. The control circuitry 140 may provide respective control signals for independently controlling each switch driver (and corresponding switch) of the switch drivers 142.

As shown, the switches 146 and 150 may each include body diodes. These body diodes allow current to flow through the switches 146 and 150, even when open (off), and toward the node 122, given that a low impedance path to the node 122 is available through the corresponding leg. The body diode of the switch 150, for example, prevents reverse current from flowing into the medium voltage supply input 120 while VHIGH is greater than VMED and while there is a low impedance path between the high voltage supply input 118 and the node 122 (i.e., while the transistor 148 is conducting). Herein, a switch or transistor is considered to be “closed”, “on”, or “activated” when a relatively low impedance path is provided between the input terminal of the switch (excluding body diode path) and the output terminal of the switch, permitting electric current to flow between its input terminal and its output terminal. Herein, a switch or transistor is considered to be “open”, “off” or “deactivated” when a relatively high impedance path is provided between its input terminal and its output terminal (excluding body diode path), such that the flow of current is reduced or blocked therebetween.

The voltage VIN at the node 122 may be set based on the highest voltage connected to the node 122 via the switching circuitry 116 (e.g., for configurations in which the transistor 148 is effectively substituted by a simple short circuit). In view of the cascode arrangement of the transistor 148 and the pass transistor 106, when the high voltage supply input 118 is to be selected as the voltage supply for the LDO regulator 100, the cascode driver 144 may be configured to provide a gate voltage to the gate terminal of the transistor 148 sufficient to allow current conduction between the source and drain terminals of the transistor 148, with VIN at the node 122 being equal to the voltage output by cascode driver 144 minus the gate-to-source voltage (VGS) of the transistor 148. In this way, the transistor 148 may limit the voltage VIN at the node 122 (e.g., to value of around 10 V in this configuration). Continuing the example, the switch 146 may be closed by the switch drivers 142 to bypass the body transistor of the switch 146 (thereby avoiding the associated voltage drop), and the switch 150 may be held open by the switch drivers 142. The voltage at the node 122 is greater than VMED in this configuration, and the body diode of the switch 150 blocks current flow from the node 122 to the medium voltage supply input 120.

As another example in which the medium voltage supply input 120 is to be selected as the voltage supply for the LDO regulator 100, the cascode driver 144 may be configured to provide a gate voltage to the gate terminal of the transistor 148 sufficient to block or otherwise prevent the conduction of current between the source and drain terminals of the transistor 148, such that the high voltage supply input 118 is effectively disconnected from the node 122 (i.e., such that the high voltage leg of the switching circuitry 116 is “open”). Continuing the example, the switch 146 may be held open by the switch drivers 142 (with current through the body diode of the switch 146 being blocked by the transistor 148), and the switch 150 may be closed by the switch drivers 142 to bypass the body transistor of the switch 150 (thereby avoiding the associated voltage drop). The voltage at the node 122 is equal to or approximately equal to VMED in this configuration.

It should be understood that the particular elements shown to be included in the switching circuitry 116 of the present example are intended to be illustrative and non-limiting. For example, in one or more other embodiments, the switches 146 and 150 may alternatively be implemented as diodes instead of switches. While such an embodiment would cause a respective voltage drop across the diode in each leg of the switching circuitry 116, it has the advantage of being less costly (e.g., due to omission of the switches 146 and 150 and the switch drivers 142).

In one or more embodiments, the transistor 148 and the pass transistor 106 may each be n-type Metal Oxide Semiconductor (nMOS) power transistors. In one or more embodiments, the transistor 148 may have a drain-to-source voltage (VDS) rating of 90 V or approximately 90 V and the pass transistor 106 may have a voltage rating of around 10 V, as non-limiting examples. The high voltage supply input 118 may be connected to a voltage source (e.g., a battery) configured to supply a voltage VHIGH of between 4V and 90 V. The medium voltage supply 120 may be connected to a voltage source (e.g., a DC-DC converter that is supplied by the battery) configured to supply a voltage VMED of between 3 V and 7 V. The transistor 148 may be configured such that a voltage drop across the transistor 148 is greater than a voltage drop across the pass transistor 106 while the high voltage leg is active (i.e., while the cascode 148 is activated), such that power dissipation in the LDO regulator 100 is distributed between the transistor 148 and the pass transistor 106 while the high voltage leg is active, and such that the power dissipated by the transistor 148 is greater than the power dissipated by the pass transistor 106.

As an example, the high voltage supply input 118 may receive a voltage VHIGH of around 50 V, the medium voltage supply input 120 may receive a voltage VMED of around 10 V, and the current limiter circuitry 110 may be configured to limit the current through the pass transistor 106 to 100 mA. Continuing the example, in the event of a short at the output node 126 (e.g., VOUT is 0 V, ground, or another applicable reference potential) while the high voltage leg is active, 5 W (i.e., 50 V*100 mA) of power is to be dissipated by the LDO regulator 100. In this scenario, the voltage VIN at the node 122 is around 10 V, such that the voltage drop across the transistor 148 is around 50 V−10 V=40 V, and the voltage drop across the pass transistor 106 is around 10 V−0 V=10 V. Given the current limit of 100 mA, the power dissipated by the transistor 148 is around 40 V*100 mA=4 W and the power dissipated by the pass transistor 106 is around 10 V*100 mA=1 W, such that the transistor 148 dissipates a majority of the power through the LDO regulator 100.

Continuing the example, in the event of a short at the output node 126 while the medium voltage leg is active, 1 W (i.e., 10 V*100 mA) of power is to be dissipated by the LDO regulator 100. In this scenario, the voltage VIN at the node 122 is around 10 V, such that the voltage drop across the pass transistor 106 is around 10 V−0 V=10 V. Given the current limit of 100 mA, the power dissipated by the pass transistor 106 is around 10 V*100 mA=1 W, such that the pass transistor 106 dissipates a majority of the power through the LDO regulator 100.

For sake of comparison, a conventional approach includes a first LDO regulator that is implemented for a high voltage supply configured to supply 50 V with a 100 mA current limit, and a separate second LDO regulator is implemented for a medium voltage supply configured to supply 10 V at 100 mA current limit. Such an arrangement would require a first pass transistor of the first (high) voltage LDO regulator to sustain 50 V*100 mA=5 W of power, and a second pass transistor of the second (medium) voltage LDO regulator to sustain 10 V*100 mA=1 W of power. In comparison, given an embodiment of the LDO regulator 100 given VHIGH=50 V, VMED=10 V, and a current limit of 100 mA, the transistor 148 would only need to sustain 4 W and the pass transistor 106 would only need to sustain 1 W (as described above). This corresponds to a potential 20% reduction of power rating (and, therefore, device size) for the transistor 148 of the LDO regulator 100, compared to the first pass transistor of the conventional approach in the above example, with equivalent temperature performance.

As shown, in the LDO regulator 100, multiple selectable voltage supply inputs 118 and 120 are coupled to a single feedback loop that includes the error amplifier 102, the pass transistor 106, and the current limiter circuitry 110. Conventional LDO regulators that have multiple error amplifiers and multiple sets of current limiter circuitry (i.e., one for each voltage supply leg), each coupled to a respective selectable voltage supply input, require separate design, testing, and stabilization of each set of current limiter circuitry and each error amplifier. In comparison, the LDO regulator 100, advantageously, only requires testing, design, and stabilization of the single error amplifier 102 and the single current limiter circuitry 110.

Additionally, re-design of such conventional LDO regulators with multiple error amplifiers and sets of current limiter circuitry requires each of the multiple LDOs and each of the multiple sets of current limiter circuitry to be re-designed. In comparison, in the event that a re-design is needed, the LDO regulator 100, advantageously, only requires re-design of the single error amplifier 102 and the single current limiter circuitry 110. Additionally, the LDO regulator 100 may be repurposed for applications using the same voltage VMED and a higher voltage VHIGH without the need for such redesign.

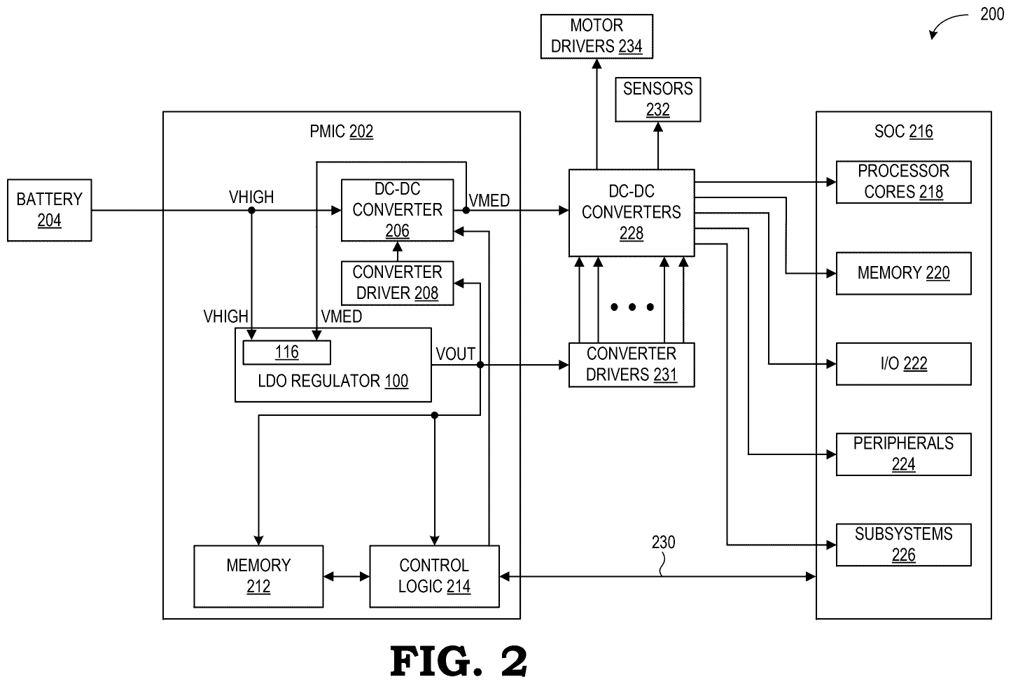

FIG. 2 shows an example of a system 200 that includes a power management integrated circuit (PMIC) 202, a battery 204, and a system-on-chip (SOC) 216. In the present example, the PMIC 202 includes, as a voltage regulation circuit, an embodiment of the LDO regulator 100 of FIG. 1. In one or more embodiments, the system 200 is an automotive system and the SOC 216 is an automotive SOC. In the present example, reference is made to the LDO regulator 100 of FIG. 1, where like elements are denoted using like reference numerals.

The PMIC 202 may include a DC-DC converter 206, the LDO regulator 100, a converter driver 208, a memory 212, and control logic 214. The LDO regulator 100 may provide a regulated output voltage VOUT that powers one or more of converter driver 208, the memory 212, and the control logic 214. The DC-DC converter 206 may receive a voltage VHIGH (e.g., around 12V to around 48 V as a non-limiting example) and may generate a voltage VMED (e.g., around 6 V to 10 V, as a non-limiting example) by stepping down the voltage VHIGH. The control logic 214 may communicate with the SOC 216 over an interface 230, and may control the DC-DC converter to scale up or scale down the voltage VMED based on instructions received from the SOC 216. In one or more embodiments, the memory 212 includes a one-time programmable (OTP) memory that can provide pre-set limits for voltage ranges and other parameters. For one or more embodiments in which the system 200 is an automotive system, the pre-set limits of the OTP memory of the memory 212 may be stored by the manufacturer of the PMIC or by a manufacturer of a vehicle in which the system 200 is disposed.

The SOC 216 may include one or more processor cores 218, a computer-readable memory 220, one or more input/output (I/O) devices 222, one or more peripheral devices 224, and one or more subsystems 226, which may each receive power from respective DC-DC converters 228, where each of the DC-DC converters 228 are coupled to receive VMED from the DC-DC converter 206. The voltage VOUT generated by the LDO regulator 100 may be provided to converter drivers 231, which are configured to drive respective converters of the DC-DC converters 228.

Each of the processor cores 218 of the SOC 216 may include at least one central processing unit (CPU) and a local cache memory. In one or more embodiments, the memory 220 may be a system memory of the SOC 216 that is connected to the processor cores 218, the I/O devices 222, the peripheral devices 224, and/or the subsystems 226 via one or more interconnects or communications busses (not shown). The memory 220 may include computer-readable instructions for operating system that may be executed by the processor cores 218 as well as other software associated with tasks performed by the SOC 216.

The I/O devices 222 may include I/O devices for applications provided by the SOC 216, such as a display, a touch screen input device, and one or more network ports, as non-limiting examples. The peripheral devices 224 may include circuitry configured to perform flash memory management, power management, interconnect management, and physical layer tasks (e.g., universal serial bus (USB) functionality), as non-limiting examples.

The system 200 may include sensors 232 (e.g., air-flow sensors, pressure sensors, temperature sensors, fuel sensors, speed sensors, voltage sensors, and/or proximity sensors, as non-limiting examples) that receive power from one or more of the DC-DC converters 228. The system 200 may include motor drivers 234 configured to drive one or more electric motors configured to convert electrical power to torque in order to turn the wheels of a vehicle that includes the system 200. The motor drivers 234 may receive power from one or more of the DC-DC converters 228.

In one or more embodiments, because the DC-DC converter 206 may be initially (e.g., at start-up of the system 200) powered by the LDO regulator 100 via the converter driver 208, the switching circuitry 116 may initially be configured to couple the output of the battery 204 to the input node (i.e., the node 122) of the LDO regulator 100 to supply the voltage VHIGH. Then, in response to determining that the DC-DC converter 206 has stabilized, the configuration of the switching circuitry 116 may be changed (e.g., by the control circuitry 140 and the cascode driver 144 to turn off or otherwise stop conduction through the transistor 148) to couple the output of the DC-DC converter 206 to the input node of the LDO regulator 100 to supply the voltage VMED. In one or more embodiments, the output of the battery 204 may correspond to or may be coupled to a first voltage supply input (e.g., the high voltage supply input 118 of FIG. 1) of the LDO regulator 100. In one or more embodiments, the output of the DC-DC converter 206 may correspond to or may be coupled to a second voltage supply input (e.g., the medium voltage supply input 120 of FIG. 1) of the LDO regulator 100.

As described above, the switching circuitry 116 of the LDO regulator 100 may include a cascode transistor coupled in a cascode arrangement with a pass transistor of the LDO regulator 100. Power dissipation in the LDO regulator 100 may be distributed between these transistors, such that the LDO regulator 100 better able to withstand adverse conditions, such as unexpected shorting of the output of the LDO regulator 100 to ground. Further, designing the LDO regulator 100 for a particular application may be simpler than designing conventional regulators, at least because design of the LDO regulator 100 involves designing a single medium-voltage error amplifier 102 (whereas conventional regulators often require designing multiple error amplifiers, including a high-voltage error amplifier to handle a high voltage supply), and involves designing a single set of current limiter circuitry 110 (whereas conventional regulators often require separate sets of current protection circuitry for each voltage supply input). The use of a single set of current limiter circuitry 110 and a single error amplifier 102 for multiple voltage supply inputs in the LDO regulator 100 may also result in advantageous reductions in size and complexity of the LDO regulator 100, compared to such conventional approaches.

The foregoing description refers to elements or nodes or features being “connected” or “coupled” together. As used herein, unless expressly stated otherwise, “connected” means that one element is directly joined to (or directly communicates with) another element, and not necessarily mechanically. Likewise, unless expressly stated otherwise, “coupled” means that one element is directly or indirectly joined to (or directly or indirectly communicates with) another element, and not necessarily mechanically. Thus, although the schematic shown in the figures depict one exemplary arrangement of elements, additional intervening elements, devices, features, or components may be present in one or more embodiments of the depicted subject matter. Furthermore, the term “amplifier” used herein should be understood to refer to a “power amplifier” unless noted otherwise.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

1-11. (canceled)

12. A voltage regulation circuit comprising:
an error amplifier configured to provide an error signal based on a comparison of a reference voltage and a voltage at a voltage divider coupled to an output node of the voltage regulation circuit;
a pass transistor configured to selectively pass current from an input node to the output node based on the error signal; and
switching circuitry configured to selectively couple one of a first voltage supply input and a second voltage supply input to the input node, the switching circuitry comprising:
a first leg that coupled between the first voltage supply input and the input node, wherein the first leg includes a transistor that is coupled in a cascode arrangement with the pass transistor; and
a second leg coupled between the second voltage supply input and the input node.

13. The voltage regulation circuit of claim 12, further comprising:
a charge pump having an input coupled to the output node, wherein the charge pump is configured to generate a charge pump voltage; and
a cascode driver configured to receive the charge pump voltage and to control an amount of current passing through the transistor of the first leg.

14. The voltage regulation circuit of claim 13, further comprising:
a first switch included in the first leg;
a second switch included in the second leg; and
one or more switch drivers coupled to the first switch and the second switch and configured to control the first switch and the second switch.

15. The voltage regulation circuit of claim 13, wherein the transistor of the first leg is a first nMOS power transistor having a first voltage rating and the pass transistor is a second nMOS power transistor having a second voltage rating that is less than the first voltage rating.

16. The voltage regulation circuit of claim 14, wherein, when the output node is at zero volts and the first voltage supply input is selected, the transistor of the first leg is configured to dissipate a majority of power in the voltage regulation circuit.

17. The voltage regulation circuit of claim 16, wherein, when the output node is at zero volts and the second voltage supply input is selected, the pass transistor is configured to dissipate a majority of power in the voltage regulation circuit.

18. The voltage regulation circuit of claim 12, wherein the first voltage supply input is configured to receive a first voltage, the second voltage supply input is configured to receive a second voltage, and the first voltage is greater than the second voltage.

19. The voltage regulation circuit of claim 12, further comprising:
current limiter circuitry coupled to a gate of the pass transistor and configured to limit current through the pass transistor.

20. A low-dropout regulator comprising:
an output node;
a voltage divider coupled to the output node;
an error amplifier configured to generate an error signal based on a comparison of a reference voltage and a voltage at the voltage divider;
a pass transistor configured to receive the error signal from the error amplifier and to selectively pass current from an input node to the output node based on the error signal; and
switching circuitry comprising:
a first leg coupled between a first voltage supply input and the input node, wherein the first leg includes a cascode transistor that is coupled in a cascode arrangement with the pass transistor; and
a second leg coupled between a second voltage supply input and the input node, wherein the second leg is coupled in parallel with the first leg.

21. The low-dropout regulator of claim 20, further comprising:
a charge pump having an input coupled to the output node, wherein the charge pump is configured to generate a charge pump voltage; and
a cascode driver configured to receive the charge pump voltage and to control an amount of current passing through the cascode transistor.

22. The low-dropout regulator of claim 21, wherein the cascode transistor is a first nMOS power transistor having a first voltage rating and the pass transistor is a second nMOS power transistor having a second voltage rating that is less than the first voltage rating.

23. The low-dropout regulator of claim 22, wherein, when the output node is shorted to ground and the first leg is active, the cascode transistor is configured to dissipate a first amount of power and the pass transistor is configured to dissipate a second amount of power that is less than the first amount of power.

24. The low-dropout regulator it of claim 23, wherein, when the output node is shorted to zero volts and the second leg is active, the pass transistor is configured to dissipate a majority of power in the low-dropout regulator.

25. The low-dropout regulator of claim 20, wherein the first voltage supply input is configured to receive a first voltage, the second voltage supply input is configured to receive a second voltage, and the first voltage is greater than the second voltage.

26. The low-dropout regulator of claim 20, further comprising:
current limiter circuitry coupled a gate of the pass transistor and configured to limit current through the pass transistor.

27. A power management integrated circuit comprising:
a battery;
a direct-current (DC)-DC converter coupled to the battery; and
a voltage regulation circuit configured to generate a regulated output voltage at an output node, the voltage regulation circuit comprising:
a voltage divider coupled to the output node;
an error amplifier configured to generate an error signal based on a comparison of a reference voltage and a voltage at the voltage divider;
a pass transistor configured to receive the error signal from the error amplifier and to selectively pass current from an input node to the output node based on the error signal; and
switching circuitry comprising:
a first leg coupled between the battery and the input node, wherein the first leg includes a cascode transistor that is coupled in a cascode arrangement with the pass transistor; and
a second leg coupled between the DC-DC converter and the input node, wherein the second leg is coupled in parallel with the first leg.

28. The power management integrated circuit of claim 27, further comprising:
a charge pump having an input coupled to the output node, wherein the charge pump is configured to generate a charge pump voltage; and
a cascode driver configured to receive the charge pump voltage and to control an amount of current passing through the cascode transistor.

29. The power management integrated circuit of claim 28, wherein the cascode transistor is a first nMOS power transistor having a first voltage rating and the pass transistor is a second nMOS power transistor having a second voltage rating that is less than the first voltage rating.

30. The power management integrated circuit of claim 29, wherein, when the output node is shorted to ground and the first leg is active, the cascode transistor is configured to dissipate a first amount of power and the pass transistor is configured to dissipate a second amount of power that is less than the first amount of power.
